(19) United States
(12) Patent Application Publication
(10) Pub. No.: US 2016/0044314 A1
(43) Pub. Date: Feb. 11, 2016

(54) SYSTEM AND METHOD FOR REUSING TRANSFORM STRUCTURE FOR MULTI-PARTITION TRANSFORM

(71) Applicant: QUALCOMM Incorporated, San Diego, CA (US)

(72) Inventor: Antonio Rinaldi, Markham (CA)

(21) Appl. No.: 14/819,329

(22) Filed: Aug. 5, 2015

Related U.S. Application Data
(60) Provisional application No. 62/035,299, filed on Aug. 8, 2014.

(51) Int. Cl. H04N 19/122; H04N 19/18; H04N 19/182; H04N 19/157; H04N 19/174

(52) U.S. Cl. CPC H04N 19/122; H04N 19/157; H04N 19/174; H04N 19/182; H04N 19/18

(57) ABSTRACT

An apparatus configured to decode a block of video data in a coded bitstream includes a memory and a processor in communication with the memory. The memory is configured to store data associated with the block of video data in the coded bitstream. The processor is configured to: determine a transform partition type of the block, the block associated with transform coefficients determined via applying one or more transform functions on a plurality of pixel values associated with the block; determine, based on the transform partition type, an order in which the transform coefficients are to be inputted to an inverse transform function corresponding to the one or more transform functions; obtain output values via inputting the transform coefficients to the inverse transform function in the determined order; and decode the block of video data in the coded bitstream based on the output values.

### INCORPORATION BY REFERENCE TO PRIORITY APPLICATION(S)

This application claims the benefit of U.S. Provisional Application No. 62/035,299, filed Aug. 8, 2014.

### TECHNICAL FIELD

This disclosure relates to the field of video coding and compression, and particularly to video compression for transmission over display links, such as display link video compression.

### BACKGROUND

Digital video capabilities can be incorporated into a wide range of displays, including digital televisions, personal digital assistants (PbAs), laptop computers, desktop monitors, digital cameras, digital recording devices, digital media players, video gaming devices, video game consoles, cellular or satellite radio telephones, video teleconferencing devices, and the like. Display links are used to connect displays to appropriate source devices. The bandwidth requirements of display links are proportional to the resolution of the displays, and thus, high-resolution displays require large bandwidth display links. Some display links do not have the bandwidth to support high resolution displays. Video compression can be used to reduce the bandwidth requirements such that lower bandwidth display links can be used to provide digital video to high resolution displays.

Others have tried to utilize image compression on the pixel data, However, such schemes are sometimes not visually lossless or can be difficult and expensive to implement in conventional display devices.

The Video Electronics Standards Association (VESA) has developed Display Stream Compression (DSC) as a standard for display link video compression. The display link video compression technique, such as DSC, should provide, among other things, picture quality that is visually lossless (i.e., pictures having a level of quality such that users cannot tell the compression is active). The display link video compression technique should also provide a scheme that is easy and inexpensive to implement in real-time with conventional hardware.

### SUMMARY

The systems, methods, and devices of this disclosure each have several innovative aspects, no single one of which is solely responsible for the desirable attributes disclosed herein.

In one aspect, a method of decoding a block of video data in a coded bitstream includes: determining a transform partition type associated with the block, the block associated with a plurality of transform coefficients determined at least in part via applying one or more transform functions on a plurality of pixel values associated with the block; determining, based on the transform partition type, an order in which the plurality of transform coefficients are to be inputted to one or more inverse transform functions corresponding to the one or more transform functions; obtaining a plurality of output values at least in part via inputting the plurality of transform coefficients to the one or more inverse transform functions in the determined order; and decoding the block of video data in the coded bitstream based at least in part on the plurality of output values.

In another aspect, an apparatus for decoding a block of video data in a coded bitstream includes a memory and a processor in communication with the memory. The memory is configured to store data associated with the block of video data in the coded bitstream. The processor is configured to: determine a transform partition type associated with the block, the block associated with a plurality of transform coefficients determined at least in part via applying one or more transform functions on a plurality of pixel values associated with the block; determine, based on the transform partition type, an order in which the plurality of transform coefficients are to be inputted to one or more inverse transform functions corresponding to the one or more transform functions; obtain a plurality of output values at least in part via inputting the plurality of transform coefficients to the one or more inverse transform functions in the determined order; and decode the block of video data in the coded bitstream based at least in part on the plurality of output values.

In another aspect, a non-transitory computer readable medium contains code that, when executed, causes an apparatus to: store data associated with a block of video data in a coded bitstream; determine a transform partition type associated with the block, the block associated with a plurality of transform coefficients determined at least in part via applying one or more transform functions on a plurality of pixel values associated with the block; determine, based on the transform partition type, an order in which the plurality of transform coefficients are to be inputted to one or more inverse transform functions corresponding to the one or more transform functions; obtain a plurality of output values at least in part via inputting the plurality of transform coefficients to the one or more inverse transform functions in the determined order; and decode the block of video data in the coded bitstream based at least in part on the plurality of output values.

In another aspect, a video coding device configured to decode a block of video data in a coded bitstream includes: means for storing data associated with a block of video data in a coded bitstream; means for determining a transform partition type associated with the block, the block associated with a plurality of transform coefficients determined at least in part via applying one or more transform functions on a plurality of pixel values associated with the block; means for determining, based on the transform partition type, an order in which the plurality of transform coefficients are to be inputted to one or more inverse transform functions corresponding to the one or more transform functions; means for obtaining a plurality of output values at least in part via inputting the plurality of transform coefficients to the one or more inverse transform functions in the determined order; and means for decoding the block of video data in the coded bitstream based at least in part on the plurality of output values.

### BRIEF DESCRIPTION OF THE DRAWINGS

FIG. 1A is a block diagram illustrating an example video encoding and decoding system that may utilize techniques in accordance with aspects described in this disclosure.

FIG. 1B is a block diagram illustrating another example video encoding and decoding system that may perform techniques in accordance with aspects described in this disclosure.

FIG. 2A is a block diagram illustrating an example of a video encoder that may implement techniques in accordance with aspects described in this disclosure.

FIG. 2B is a block diagram illustrating an example of a video decoder that may implement techniques in accordance with aspects described in this disclosure.

FIG. 3 is an example of transform partitioning on the encoder side.

FIG. 4 is an example of transform partitioning on the decoder side.

FIGS. 5A-5D illustrate example pixel partitions used in various partition types.

FIGS. 6A-6D illustrate example implementations of the various partition types using the transform structure of a single inverse transform.

FIG. 7 is a block diagram illustrating a method performed by a decoder for reusing transform structure for multi-partition transforms in accordance with aspects described in this disclosure.

FIG. 8 is an example of transform partitioning on the decoder side in accordance with aspects described in this disclosure.

### DETAILED DESCRIPTION

In general, this disclosure relates to methods of improving video compression techniques, such as those utilized in display link video compression, for example. More specifically, the present disclosure relates to systems and methods for implementing multi-length transform functions using a single transform structure.

While certain embodiments are described herein in the context of the Display Stream Compression (DSC) standard, which is an example of a display link video compression technique, one having ordinary skill in the art would appreciate that systems and methods disclosed herein may be applicable to any suitable video coding standard. For example, embodiments disclosed herein may be applicable to one or more of the following standards: International Telecommunication Union (ITU) Telecommunication Standardization Sector (ITU-T) H.261, International Organization for Standardization/International Electrotechnical Commission (ISO/IEC) Moving Picture Experts Group-1 (MPEG-1) Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), High Efficiency Video Coding (HEVC), and any extensions to such standards. Also, the techniques described in this disclosure may become part of standards developed in the future. In other words, the techniques described in this disclosure may be applicable to previously developed video coding standards, video coding standards currently under development, and forthcoming video coding standards. Further, the techniques described in the present disclosure may be applicable to any coding scheme that involves transform-based image/video compression.

Video encoders may apply one or more transforms on the pixel values or residual values to be coded in order to achieve additional compression. For example, an encoder may apply one or more transforms on a block of video data (e.g., pixel values or residual values) and obtain a transform coefficient block (e.g., a block of transform coefficients corresponding to the block of video data). In some implementations, the encoder performs a number of transforms of different sizes (e.g., four different sets of transforms) and selects the transform that yields the best performance (e.g., closest to the desired rate-distortion performance) for the particular block or portion of the image or video data. The encoder may signal a transform select signal in the bitstream to indicate the selected transform to the decoder.

In existing decoder hardware implementations, a separate inverse transform block is used for each transform partition type. For example, if the encoder is configured to select from four different partition types, a corresponding decoder that is configured to decode bitstreams generated by the encoder also includes four sets of hardware (e.g., registers, adders, subtractors, etc. that are not shared among each other) each corresponding to the four different partition types. Each set of hardware produces a set of output values that are fed to a multiplexer (MUX), for example, and the decoder selects the appropriate set of output values based on the partition select signal.

However, using multiple inverse transform blocks to decode the incoming partitioned bitstream detrimentally affects the cost-effectiveness of the decoder, since hardware implementation is especially sensitive to chip area and/or implementation cost on the decoder side. Thus, an improved method for decoding transform-coded bitstreams that involve multiple transform partition sizing in a manner that is more cost-effective is desired.

In the present disclosure, an improved method of decoding transform-coded bitstreams that involve multiple transform partition sizing is described. For example, an example implementation of a 16-point transform may include hardware such as adders and/or subtractors. These adders and/or subtractors may be utilized to perform other transforms such as 8-point and 4-point transforms without having to add the full transform structure necessary to implement such 8-point and 4-point transforms that are separate and independent from the hardware used for implementing the 16-point transform. In other words, by reusing certain portions of the hardware used to implement the various transforms that the encoder and/or decoder may need to perform, the hardware requirements for implementing such transforms can be reduced.

### Video Coding Standards

A digital image, such as a video image, a TV image, a still image or an image generated by a video recorder or a computer, may include pixels or samples arranged in horizontal and vertical lines. The number of pixels in a single image is typically in the tens of thousands. Each pixel typically contains luminance and chrominance information. Without compression, the sheer quantity of information to be conveyed from an image encoder to an image decoder would render real-time image transmission impractical. To reduce the amount of information to be transmitted, a number of different compression methods, such as JPEG, MPEG and H.263 standards, have been developed.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), and HEVC including extensions of such standards.

In addition, a video coding standard, namely DSC, has been developed by VESA. The DSC standard is a video compression standard which can compress video for transmission over display links. As the resolution of displays increases, the bandwidth of the video data required to drive the displays increases correspondingly. Some display links may not have the bandwidth to transmit all of the video data to the display for such resolutions. Accordingly, the DSC standard specifies a compression standard for interoperable, visually lossless compression over display links.

The DSC standard is different from other video coding standards, such as H.264 and HEVC. DSC includes intra-frame compression, but does not include inter-frame compression, meaning that temporal information may not be used by the DSC standard in coding the video data. In contrast, other video coding standards may employ inter-frame compression in their video coding techniques.

### Video Coding System

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with, any other aspect of the present disclosure. For example, an apparatus may be implemented or a method may be practiced using any number of the aspects set forth herein. In addition, the scope of the present disclosure is intended to cover such an apparatus or method which is practiced using other structure, functionality, or structure and functionality in addition to or other than the various aspects of the present disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The attached drawings illustrate examples. Elements indicated by reference numbers in the attached drawings correspond to elements indicated by like reference numbers in the following description. In this disclosure, elements having names that start with ordinal words (e.g., “first,” “second,” “third,” and so on) do not necessarily imply that the elements have a particular order. Rather, such ordinal words are merely used to refer to different elements of a same or similar type.

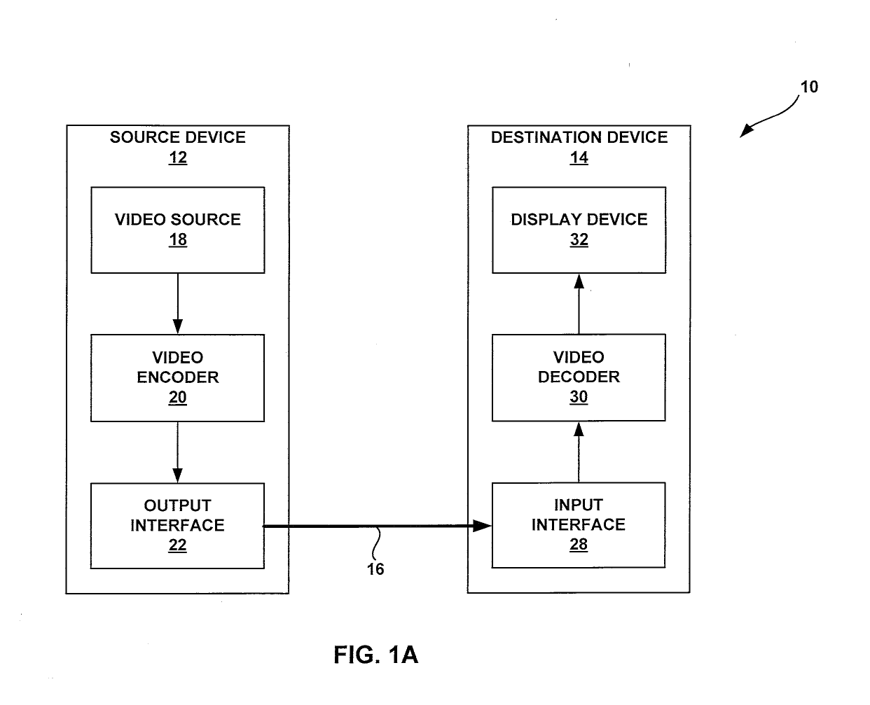

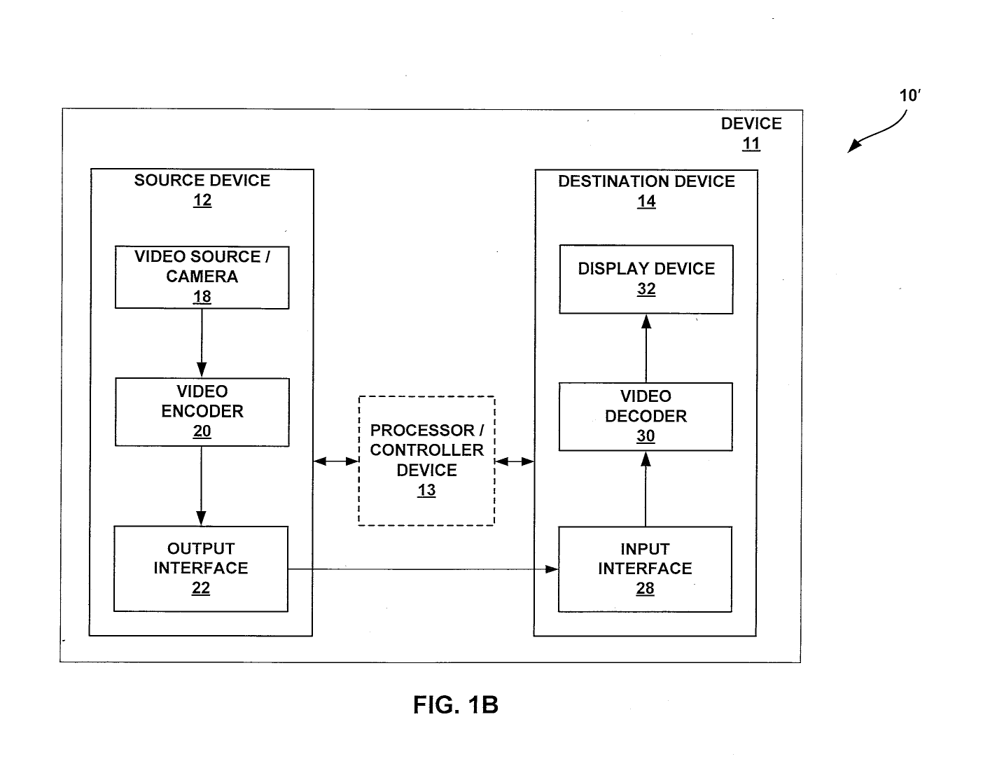

FIG. 1A is a block diagram that illustrates an example video coding system 10 that may utilize techniques in accordance with aspects described in this disclosure. As used described herein, the term “video coder” or “coder” refers generically to both video encoders and video decoders. In this disclosure, the terms “video coding” or “coding” may refer generically to video encoding and video decoding. In addition to video encoders and video decoders, the aspects described in the present application may be extended to other related devices such as transcoders (e.g., devices that can decode a bitstream and re-encode another bitstream) and middleboxes (e.g., devices that can modify, transform, and/or otherwise manipulate a bitstream).

As shown in FIG. 1A, video coding system 10 includes a source device 12 (i.e., “video coding device 12” or “coding device 12”) that generates encoded video data to be decoded at a later time by a destination device 14 (i.e., “video coding device 14” or “coding device 14”). In the example of FIG. 1A, the source device 12 and destination device 14 constitute separate devices. It is noted, however, that the source device 12 and destination device 14 may be on or part of the same device, as shown in the example of FIG. 1B.

With reference once again, to FIG. 1A, the source device 12 and the destination device 14 may respectively comprise any of a wide range of devices (also referred to as video coding devices) including desktop computers, notebook (e.g., laptop) computers, tablet computers, set-top boxes, telephone handsets such as so-called “smart” phones, so-called “smart” pads, televisions, cameras, display devices, digital media players, video gaming consoles, video streaming device, or the like. In various embodiments, the source device 12 and the destination device 14 may be equipped for (i.e., configured to communicate via) wireless communication.

The video coding devices 12, 14 of the video coding system 10 may be configured to communicate via wireless networks and radio technologies, such as wireless wide area network (WWAN) (e.g., cellular) and/or wireless local area network (WLAN) carriers. The terms “network” and “system” are often used interchangeably. Each of the video coding devices 12, 14 may be a user equipment (UE), a wireless device, a terminal, a mobile station, a subscriber unit, etc.

, The WWAN carriers may include, for example, wireless communication networks such as Code Division Multiple Access (CDMA), Time Division Multiple Access (TDMA), Frequency Division Multiple Access (FDMA), Orthogonal FDMA (OFDMA), Single-Carrier FDMA (SC-FDMA) and other networks. A CDMA network may implement a radio technology such as Universal Terrestrial Radio Access (UTRA), CDMA2000, etc. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS), 3GPP Long Term Evolution (LTE) and LTE-Advanced (LTE-A) are new releases of UMTS that use E-UTRA, UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2).

The video coding devices 12, 14 of the video coding system 10 may also communicate with each over via a WLAN base station according to one or more standards, such as the IEEE 802.11 standard, including, for example these amendments: 802,11a-1999 (commonly called “802.11a”), 802.11b-1999 (commonly called “802.11b”), 802.11g-2003 (commonly called “802.11g”), and so on.

The destination device 14 may receive, via link 16, the encoded video data to be decoded. The link 16 may comprise any type of medium or device capable of moving the encoded video data from the source device 12 to the destination device 14. In the example of FIG. 1A, the link 16 may comprise a communication medium to enable the source device 12 to transmit encoded video data to the destination device 14 in real-time. The encoded video data may be modulated according to a communication standard, such as a wireless communication protocol, and transmitted to the destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In the example of FIG. 1A, the source device 12 includes a video source 18, a video encoder 20 (also referred to as simply encoder 20) and an output interface 22. In some cases, the output interface 22 may include a modulator/demodulator (modem) and/or a transmitter. In the source device 12, the video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if the video source 18 is a video camera, the source device 12 and the destination device 14 may form so-called “camera phones” or “video phones”, as illustrated in the example of FIG. 1B, However, the techniques described in this disclosure may be applicable to video coding in general, and may be applied to wireless and/or wired applications.

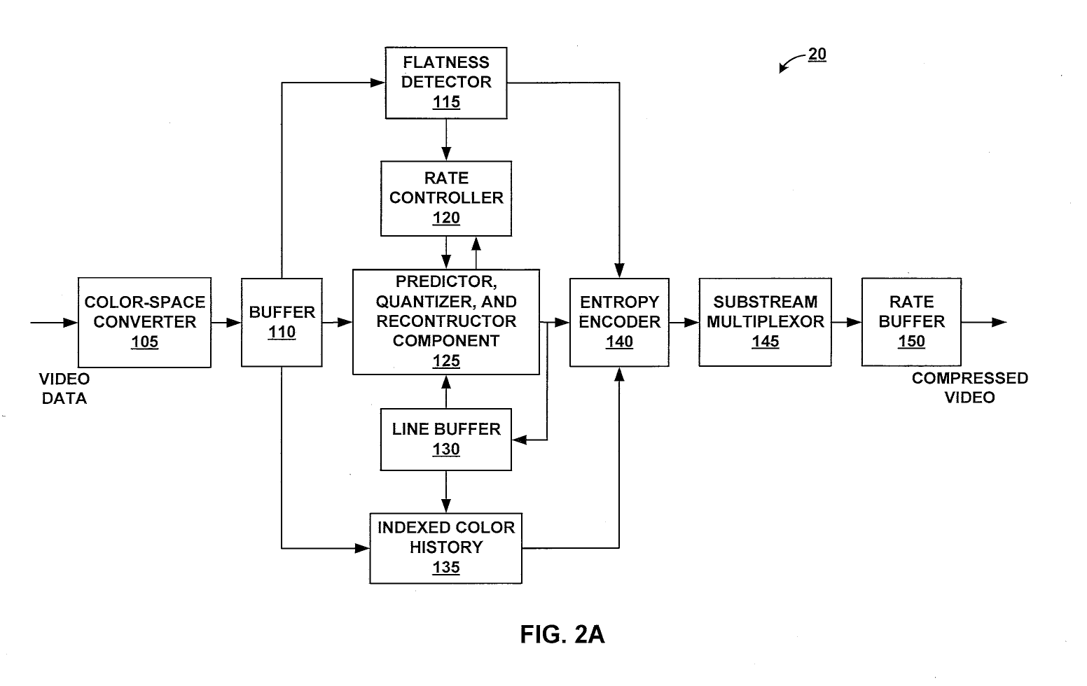

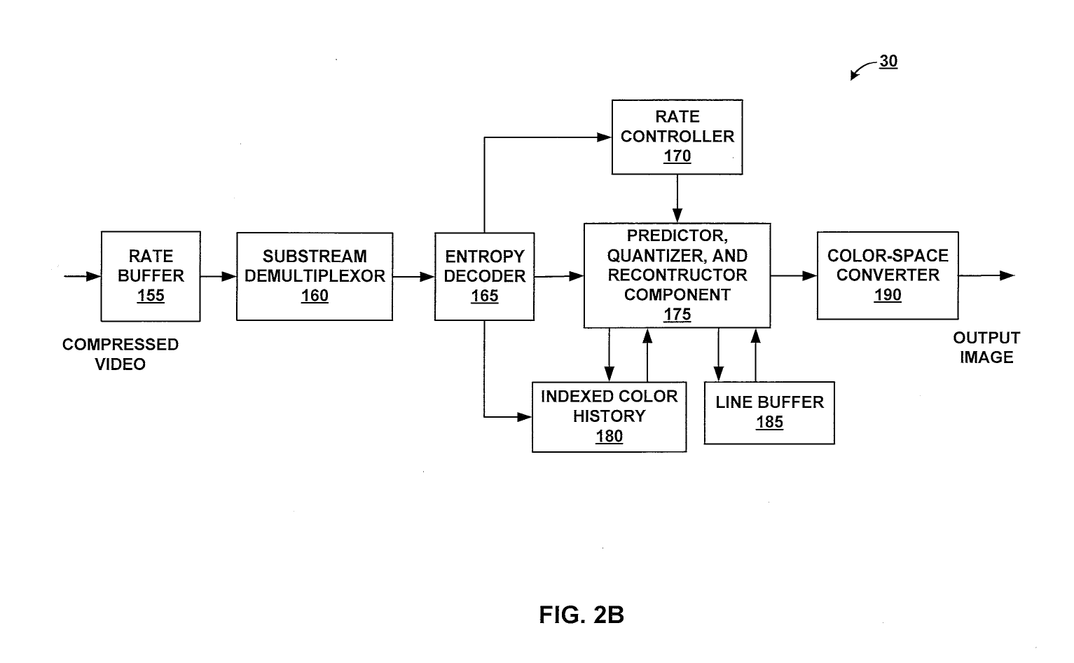

The captured, pre-captured, or computer-generated video may be encoded by the video encoder 20. The encoded video data may be transmitted to the destination device 14 via the output interface 22 of the source device 12. The encoded video data may also (or alternatively) be stored onto the storage device 31 for later access by the destination device 14 or other devices, for decoding and/or playback. The video encoder 20 illustrated in FIGS. 1A and 1B may comprise the video encoder 20 illustrated FIG. 2A or any other video encoder described herein.

In the example of FIG. 1A, the destination device 14 includes the input interface 28, a video decoder 30 (also referred to as simply decoder 30), and a display device 32. In some cases, the input interface 28 may include a receiver and/or a modem. The input interface 28 of the destination device 14 may receive the encoded video data over the link 16 and/or from the storage device 31. The encoded video data communicated over the link 16, or provided on the storage device 31, may include a variety of syntax elements generated by the video encoder 20 for use by a video decoder, such as the video decoder 30, in decoding the video data. Such syntax elements may be included with the encoded video data transmitted on a communication medium, stored on a storage medium, or stored a file server. The video decoder 30 illustrated in FIGS. 1A and 1B may comprise the video decoder 30 illustrated in FIG. 2B or any other video decoder described herein.

The display device 32 may be integrated with, or external to, the destination device 14. In some examples, the destination device 14 may include an integrated display device and also be configured to interface with an external display device. In other examples, the destination device 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In related aspects, FIG. 1B shows an example video coding system 10′ wherein the source device 12 and the destination device 14 are on or part of a device 11. The device 11 may be a telephone handset, such as a “smart” phone or the like. The device 11 may include a processor/controller device 13 (optionally present) in operative communication with the source device 12 and the destination device 14. The video coding system 10′ of FIG. 1B, and components thereof, are otherwise similar to the video coding system 10 of FIG. 1A, and components thereof.

The video encoder 20 and the video decoder 30 may operate according to a video compression standard, such as DSC. Alternatively, the video encoder 20 and the video decoder 30 may operate according to other proprietary or industry standards, such as the ITU-T H.264 standard, alternatively referred to as MPEG-4, Part 10, AVC, HEVC or extensions of such standards. The techniques of this disclosure, however, are not limited to any particular coding standard. Other examples of video compression standards include MPEG-2 and ITU-T H.263.

Although not shown in the examples of FIGS. 1A and 1B, the video encoder 20 and the video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder in a respective device.

### Video Coding Process

As mentioned briefly above, the video encoder 20 encodes video data. The video data may comprise one or more pictures. Each of the pictures is a still image forming part of a video. In some instances, a picture may be referred to as a video “frame,” When the video encoder 20 encodes the video data (e.g., video coding layer (VCL) data and/or non-VCL data), the video encoder 20 may generate a bitstream. The bitstream may include a sequence of bits that form a coded representation of the video data. The bitstream may include coded pictures and associated data. A coded picture is a coded representation of a picture. VCL data may include coded picture data (i.e., information associated with samples of a coded picture(s)) and non-VCL data may include control information (e.g., parameter sets and/or supplemental enhancement information) associated with the one or more coded pictures.

To generate the bitstream, the video encoder 20 may perform encoding operations on each picture in the video data. When the video encoder 20 performs encoding operations on the pictures, the video encoder 20 may generate a series of coded pictures and associated data. The associated data may include a set of coding parameters such as a quantization parameter (QP). To generate a coded picture, the video encoder 20 may partition a picture into equally-sized video blocks. A video block may be a two-dimensional array of samples. The coding parameters may define a coding option (e.g., a coding mode) for every block of the video data. The coding option may be selected in order to achieve a desired rate-distortion performance.

In some examples, the video encoder 20 may partition a picture into a plurality of slices. Each of the slices may include a spatially distinct region in an image (e.g., a frame) that can be decoded independently without information from the rest of the regions in the image or frame. Each image or video frame may be encoded in a single slice or each image or video frame may be encoded in several slices, In DSC, the number of bits allocated to encode each slice may be substantially constant. As part of performing an encoding operation on a picture, the video encoder 20 may perform encoding operations on each slice of the picture. When the video encoder 20 performs an encoding operation on a slice, the video encoder 20 may generate encoded data associated with the slice. The encoded data associated with the slice may be referred to as a “coded slice.”

### DSC Video Encoder

FIG. 2A is a block diagram illustrating an example of the video encoder 20 that may implement techniques in accordance with aspects described in this disclosure. The video encoder 20 may be configured to perform some or all of the techniques of this disclosure. In some examples, the techniques described in this disclosure may be shared among the various components of the video encoder 20. In some examples, additionally or alternatively, a processor (not shown) may be configured to perform some or all of the techniques described in this disclosure.

For purposes of explanation, this disclosure describes the video encoder 20 in the context of DSC coding. However, the techniques of this disclosure may be applicable to other coding standards or methods.

In the example of FIG. 2A, the video encoder 20 includes a plurality of functional components. The functional components of the video encoder 20 include a color-space converter 105, a buffer, 110, a flatness detector 115, a rate controller 120, a predictor, quantizer, and reconstructor component 125, a line buffer 130, an indexed color history 135, an entropy encoder 140, a substream multiplexor 145, and a rate buffer 150. In other examples, the video encoder 20 may include more, fewer, or different functional components.

The color-space 105 converter may convert an input color-space to the color-space used in the coding implementation. For example, in one exemplary embodiment, the color-space of the input video data is in the red, green, and blue (RGB) color-space and the coding is implemented in the luminance Y, chrominance green Cg, and chrominance orange Co (YCgCo) color-space. The color-space conversion may be performed by method(s) including shifts and additions to the video data. It is noted that input video data in other color-spaces may be processed and conversions to, other color-spaces may also be performed.

In related aspects, the video encoder 20 may include the buffer 110, the line buffer 130, and/or the rate buffer 150. For example, the buffer 110 may hold (e.g., store) the color-space converted video data prior to its use by other portions of the video encoder 20. In another example, the video data may be stored in the RGB color-space and color-space conversion may be performed as needed, since the color-space converted data may require more bits.

The rate buffer 150 may function as part of the rate control mechanism in the video encoder 20, which will be described in greater detail below in connection with rate controller 120. The number of bits spent on encoding each block can vary highly substantially based on the nature of the block. The rate buffer 150 can smooth the rate variations in the compressed video. In some embodiments, a constant bit rate (CBR) buffer model is employed in which bits stored in the rate buffer (e.g., the rate buffer 150) are removed from the rate buffer at a constant bit rate. In the CBR buffer model, if the video encoder 20 adds too many bits to the bitstream, the rate buffer 150 may overflow. On the other hand, the video encoder 20 may need to add enough bits in order to prevent underflow of the rate buffer 150.

On the video decoder side, the bits may be added to rate buffer 155 of the video decoder 30 (see FIG. 2B which is described in further detail below) at a constant bit rate, and the video decoder 30 may remove variable numbers of bits for each block. To ensure proper decoding, the rate buffer 155 of the video decoder 30 should not “underflow” or “overflow” during the decoding of the compressed bit stream.

In some embodiments, the buffer fullness (BF) can be defined based on the values BufferCurrentSize representing the number of bits currently in the buffer and BufferMaxSize representing the size of the rate buffer 150, i.e., the maximum number of bits that can be stored in the rate buffer 150 at any point in time. The BF may be calculated as:

BF=((BufferCurrentSize*100)/BufferMaxSize)

The flatness detector 115 can detect changes from complex (i.e., non-flat) areas in the video data to flat (i.e., simple or uniform) areas in the video data. The terms “complex” and “flat” will be used herein to generally refer to the difficulty for the video encoder 20 to encode the respective regions of the video data. Thus, the term complex as used herein generally describes a region of the video data as being complex for the video encoder 20 to encode and may, for example, include textured video data, high spatial frequency, and/or other features which are complex to encode. The term flat as used herein generally describes a region of the video data as being simple for the video encoder 20 to encoder and may, for example, include a smooth gradient in the video data, low spatial frequency, and/or other features which are simple to encode. The transitions between complex and flat regions may be used by the video encoder 20 to reduce quantization artifacts in the encoded video data. Specifically, the rate controller 120 and the predictor, quantizer, and reconstructor component 125 can reduce such quantization artifacts when the transitions from complex to flat regions are identified.

The rate controller 120 determines a set of coding parameters, e.g., a QP. The QP may be adjusted by the rate controller 120 based on the buffer fullness of the rate buffer 150 and image activity of the video data in order to maximize picture quality for a target bitrate which ensures that the rate buffer 150 does not overflow or underflow. The rate controller 120 also selects a particular coding option (e.g., a particular mode) for each block of the video data in order to achieve the optimal rate-distortion performance. The rate controller 120 minimizes the distortion of the reconstructed images such that the rate controller 120 satisfies the bit-rate constraint, i.e., the overall actual coding rate fits within the target bit rate.

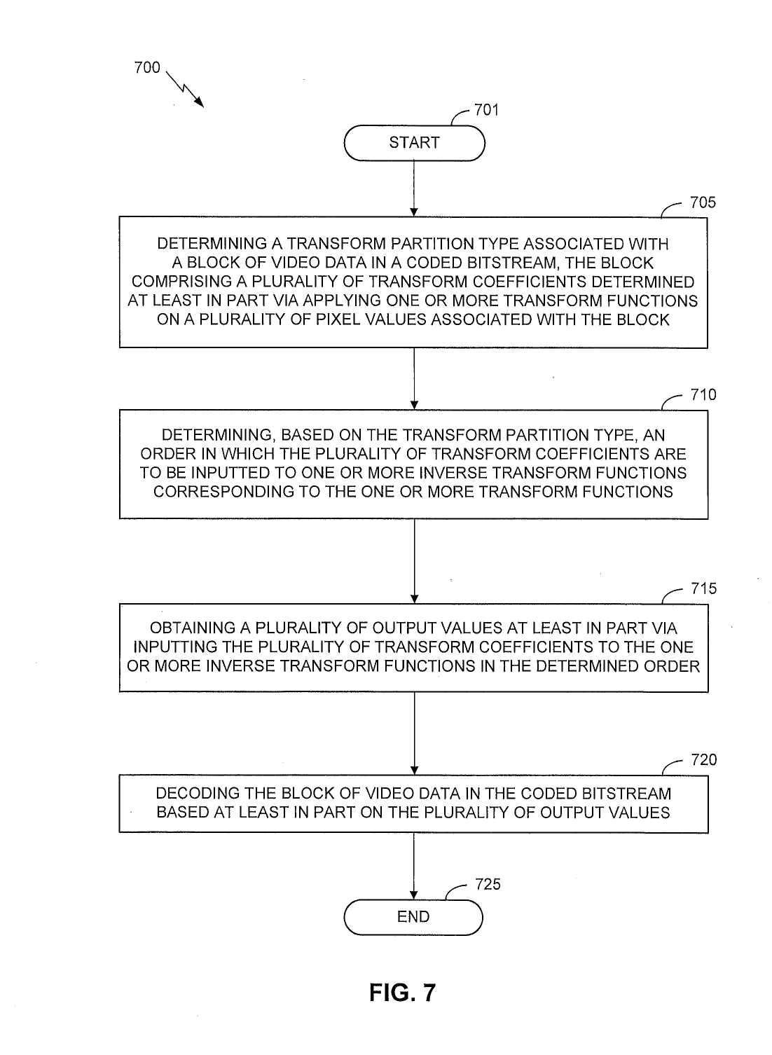

The predictor, quantizer, and reconstructor component 125 may perform at least three encoding operations of the video encoder 20. The predictor, quantizer, and reconstructor component 125 may perform prediction in a number of different modes. One example predication mode is a modified version of median-adaptive prediction. Median-adaptive prediction may be implemented by the lossless JPEG standard (JPEG-LS). The modified version of median-adaptive prediction which may be performed by the predictor, quantizer, and reconstructor component 125 may allow for parallel prediction of three consecutive sample values. Another example prediction mode is block prediction. In block prediction, samples are predicted from previously reconstructed pixels in the line above or to the left in the same line. In some embodiments, the video encoder 20 and the video decoder 30 may both perform an identical search on reconstructed pixels to determine the block prediction usages, and thus, no bits need to be sent in the block prediction mode. In other embodiments, the video encoder 20 may perform the search and signal block prediction vectors in the bitstream, such that the video decoder 30 need not perform a separate search. A midpoint prediction mode may also be implemented in which samples are predicted using the midpoint of the component range. The midpoint prediction mode may enable bounding of the number of bits required for the compressed video in even the worst-case sample. As further discussed below with reference to FIG. 7, the predictor, quantizer, and reconstructor component 125 may be configured to code (e.g., encode or decode) the block of video data (or any other unit of prediction) by performing the methods illustrated in FIG. 7.

The predictor, quantizer, and reconstructor component 125 also performs quantization. For example, quantization may be performed via a power-of-2 quantizer which may be implemented using a shifter. It is noted that other quantization techniques may be implemented in lieu of the power-of-2 quantizer. The quantization performed by the predictor, quantizer, and reconstructor component 125 may be based on the QP determined by the rate controller 120. Finally, the predictor, quantizer, and reconstructor component 125 also performs reconstruction which includes adding the inverse quantized residual to the predicted value and ensuring that the result does not fall outside of the valid range of sample values.

It is noted that the above-described example approaches to prediction, quantization, and reconstruction performed by the predictor, quantizer, and reconstructor component 125 are merely illustrative and that other approaches may be implemented. It is also noted that the predictor, quantizer, and reconstructor component 125 may include subcomponent(s) for performing the prediction, the quantization, and/or the reconstruction. It is further noted that the prediction, the quantization, and/or the reconstruction may be performed by several separate encoder components in lieu of the predictor, quantizer, and reconstructor component 125.

The line buffer 130 holds (e.g., stores) the output from the predictor, quantizer, and reconstructor component 125 so that the predictor, quantizer, and reconstructor component 125 and the indexed color history 135 can use the buffered video data. The indexed color history 135 stores recently used pixel values. These recently used pixel values can be referenced directly by the video encoder 20 via a dedicated syntax.

The entropy encoder 140 encodes the prediction residuals and any other data (e.g., indices identified by the predictor, quantizer, and reconstructor component 125) received from the predictor, quantizer, and reconstructor component 125 based on the indexed color history 135 and the flatness transitions identified by the flatness detector 115. In some examples, the entropy encoder 140 may encode three samples per clock per substream encoder. The substream multiplexor 145 may multiplex the bitstream based on a headerless packet multiplexing scheme. This allows the video decoder 30 to run three entropy decoders in parallel, facilitating the decoding of three pixels per clock. The substream multiplexor 145 may optimize the packet order so that the packets can be efficiently decoded by the video decoder 30. It is noted that different approaches to entropy coding may be implemented, which may facilitate the decoding of power-of-2 pixels per clock (e.g., 2 pixels/clock or 4 pixels/clock).

### DSC Video Decoder

FIG. 2B is a block diagram illustrating an example of the video decoder 30 that may implement techniques in accordance with aspects described in this disclosure. The video decoder 30 may be configured to perform some or all of the techniques of this disclosure. In some examples, the techniques described in this disclosure may be shared among the various components of the video decoder 30. In some examples, additionally or alternatively, a processor (not shown) may be configured to perform some or all of the techniques described in this disclosure.

For purposes of explanation, this disclosure describes the video decoder 30 in the context of DSC coding. However, the techniques of this disclosure may be applicable to other coding standards or methods.

In the example of FIG. 2B, the video decoder 30 includes a plurality of functional components. The functional components of the video decoder 30 include a rate buffer 155, a substream demultiplexor 160, an entropy decoder 165, a rate controller 170, a predictor, quantizer, and reconstructor component 175, an indexed color history 180, a line buffer 185, and a color-space converter 190. The illustrated components of the video decoder 30 are analogous to the corresponding components described above in connection with the video encoder 20 in FIG. 2A. As such, each of the components of the video decoder 30 may operate in a similar fashion to the corresponding components of the video encoder 20 as described above.

### Transform Coding

In some embodiments of the present disclosure, video encoders (e.g., the video encoder 20) may apply one or more transforms on the pixel values or residual values to achieve additional compression. For example, an encoder (e.g., the video encoder 20) may apply one or more transforms on a block of video data (e.g., pixel values or residual values) and obtain a transform coefficient block (e.g., a block of transform coefficients corresponding to the block of video data). As discussed above, after generating a transform coefficient block, the encoder may perform a quantization process on the transform coefficient block, where transform coefficients are quantized to possibly reduce the amount of data used to represent the transform coefficients, providing further compression.

Similarly, a video decoder (e.g., the video decoder 30) may receive a bitstream generated by the encoder, where the bitstream includes a coded representation of the video data encoded by the encoder. When the decoder receives the bitstream, the decoder parses the bitstream and extracts syntax elements from the bitstream, and may reconstruct the pictures of the video data based on the syntax elements extracted from the bitstream. The process to reconstruct the video data based on the syntax elements may be generally reciprocal to the process performed by the encoder to generate the syntax elements. For example, the decoder may inverse quantize transform coefficient blocks in the bitstream and perform inverse transforms on the transform coefficient blocks to reconstruct the blocks of video data coded in the bitstream.

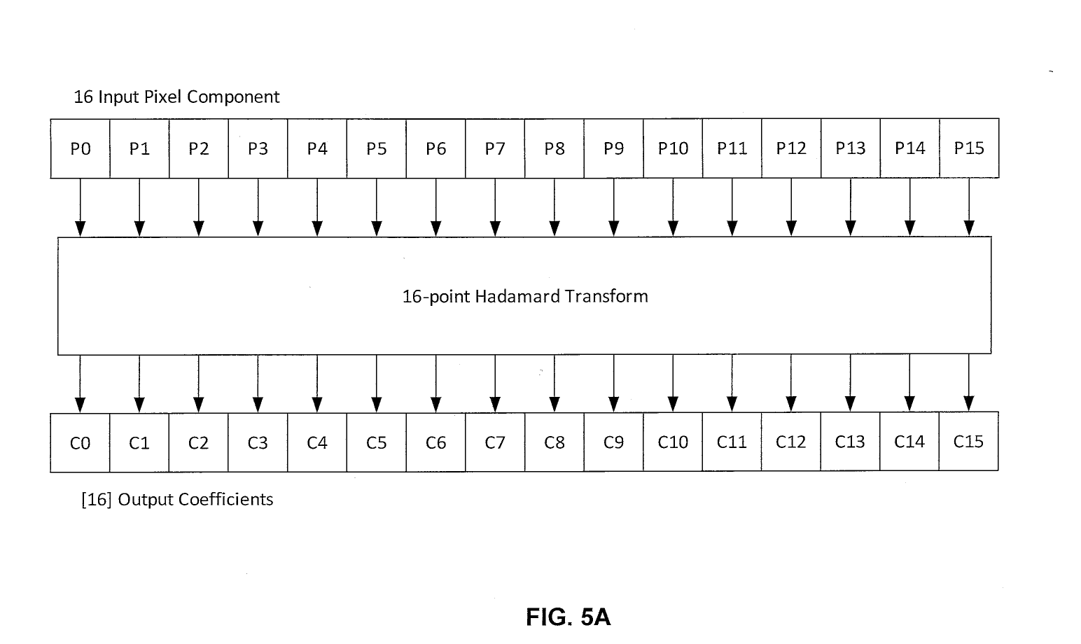

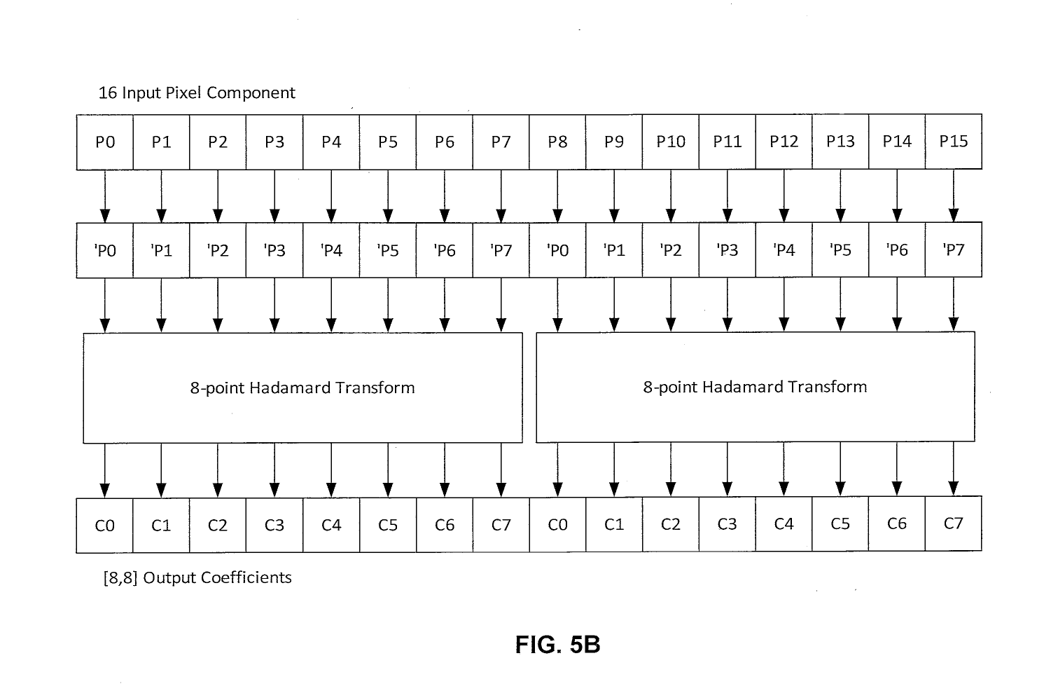

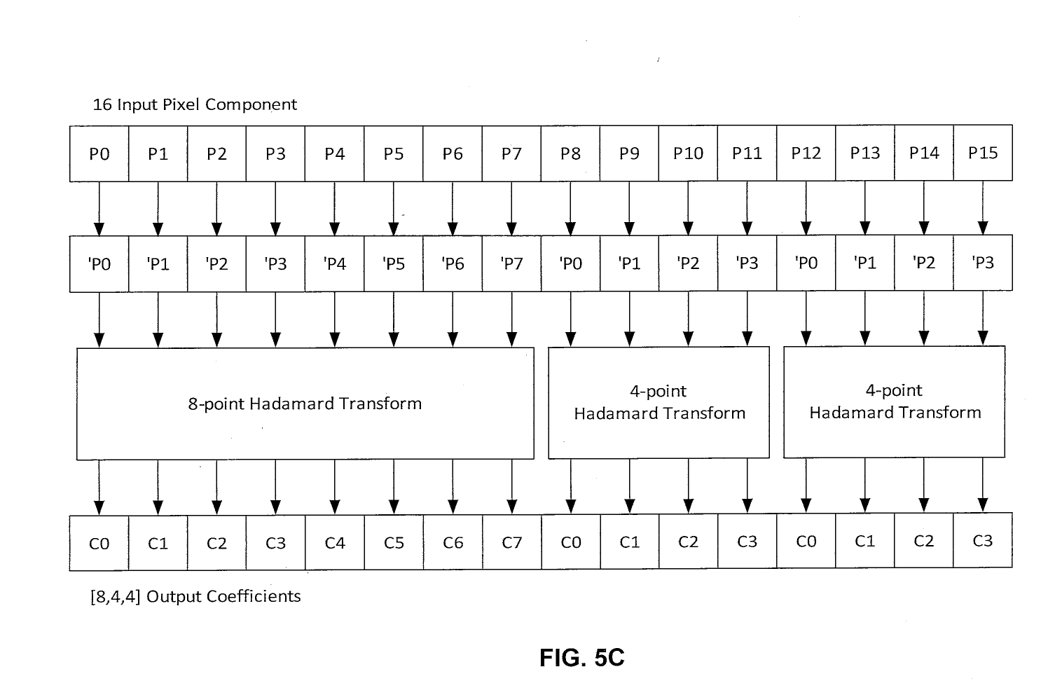

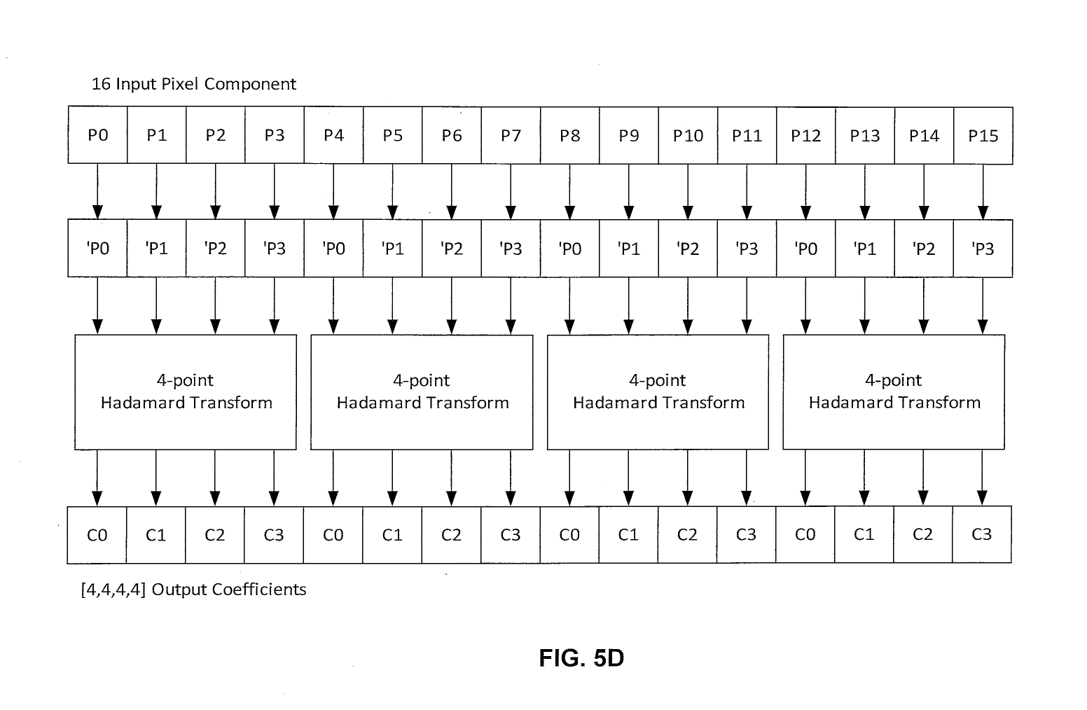

In some implementations of the present disclosure, the encoder (e.g., the video encoder 20) performs a number of transforms of different sizes (e.g., four different sets of transforms) and selects the transform that yields the best performance (e.g., closest to the desired rate-distortion performance) for the particular block or portion of the image or video data. For example, the encoder may perform (i) a single 16-point transform, (ii) two 8-point transforms, (iii) one 8-point transform and two 4-point transforms, or (iv) four 4-point transforms, where each option utilizes the same number of inputs (e.g., pixel data). Thus, each block of 16 pixels can be encoded using a transform mode, and the 16 pixels to be transform-coded can be further partitioned into smaller block sizes (e.g., partitions of 4 pixels, 8 pixels, or any other size) before being inputted to transform functions. In the example of 16-pixel blocks, the 16-pixel block may represent (i) a single row of 16 pixels in a picture coded in the bitstream, (ii) two rows of 8 pixels in the picture coded in the bitstream, (iii) four rows of 4 pixels in a picture coded in the bitstream, or (iv) any other arrangement of 16 pixels in the picture coded in the bitstream. FIGS. 5A-5D illustrate how the pixel data can be divided into multiple partitions when more than one transform is to be performed on the pixel data.

After performing the various sets of transforms, the encoder may analyze the distortion and the bit rate associated with each option and select one of the options based on the desired performance. The encoder may indicate the selected option to the decoder by signaling a flag or syntax element in the coded bitstream.

### Partition Format

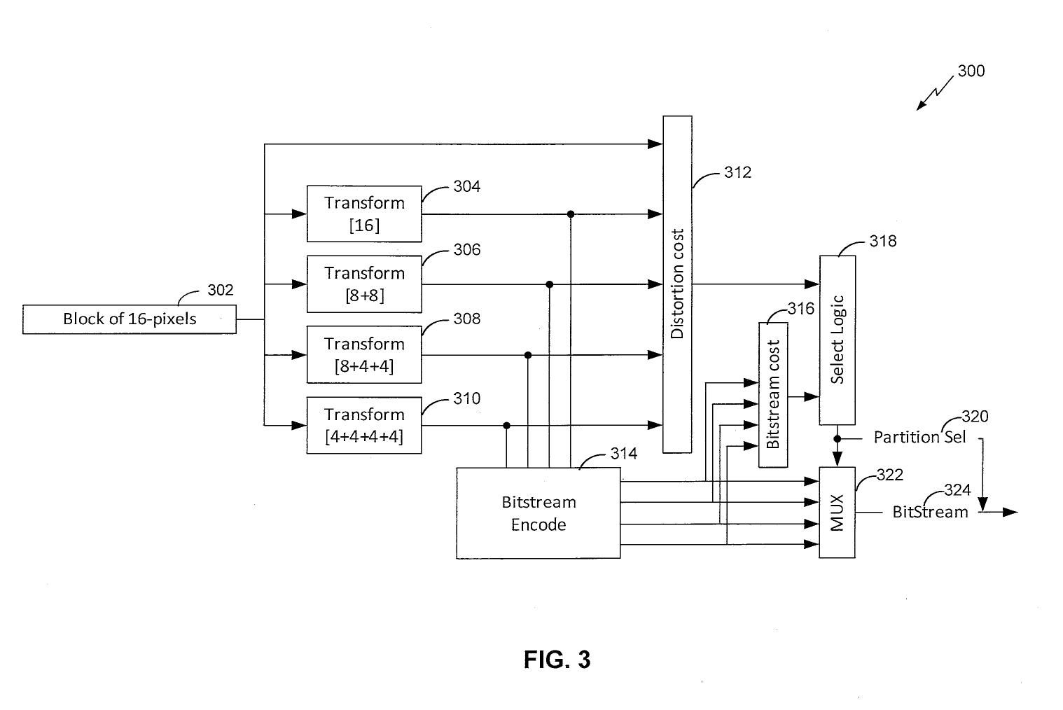

In some embodiments, the encoder (e.g., the video encoder 20) divides the pixels in the pictures or frames to be coded into smaller partitions (e.g., 16-pixel blocks) for performing transform-based image compression. For example, the partition format (also referred to herein as transform partition type) used in a given coding scheme may consist of (i) one 16-pixel block, (ii) two 8-pixel blocks, (iii) a mix of one 8-pixel block and two 4-pixel blocks, and (iv) four 4-pixel blocks, as illustrated in FIG. 3. In the example of FIG. 3, a block 302 including 16 pixels is inputted to transform blocks 304, 306, 308, and 310 corresponding to different combinations of transforms. The encoder (e.g., the video encoder 20) then calculates the distortion cost 312 corresponding to each of the transforms associated with the transform blocks 304, 306, 308, and 310. In FIG. 3, each of the transform blocks 304, 306, 308, and 310 represents a different transform partition type. For example, the transform block 304 corresponds to a single 16-point transform, the transform block 306 corresponds to two 8-point transforms, the transform block 308 corresponds to a mix of one 8-point transform and two 4-point transforms, and the transform block 310 corresponds to four 4-point transforms. Additionally, the transform coefficients corresponding to each of the transform blocks 304, 306, 308, and 310 are coded at the bitstream encode block 314 into the bitstream and the bitstream cost 316 corresponding to each of the transform blocks 304, 306, 308, and 310 is calculated. Based on the distortion cost 312 and the bitstream cost 316 corresponding to each of the transform blocks 304, 306, 308, and 310, the select logic 318 of the encoder selects the transform partition type associated with one of the transform blocks 304, 306, 308, or 310, which is indicated by the partition select flag or syntax element 320. Thus, in some embodiments, the select logic 318 selects the transform partition type that yields the lowest encode pixel distortion with the lowest bitstream cost. For example, when coding a given picture, the encoder may determine that one portion of the given picture (e.g., a 16-pixel block within the given picture) can be best coded if two 8-pixel blocks (e.g., 8-point transforms) are used, and another portion of the given picture can be best coded if four 4-pixel blocks (e.g., 4-point transforms) are used. Based on the value of the partition select flag or syntax element 320, the MUX 322 outputs the bitstream 324 to be sent to the decoder.

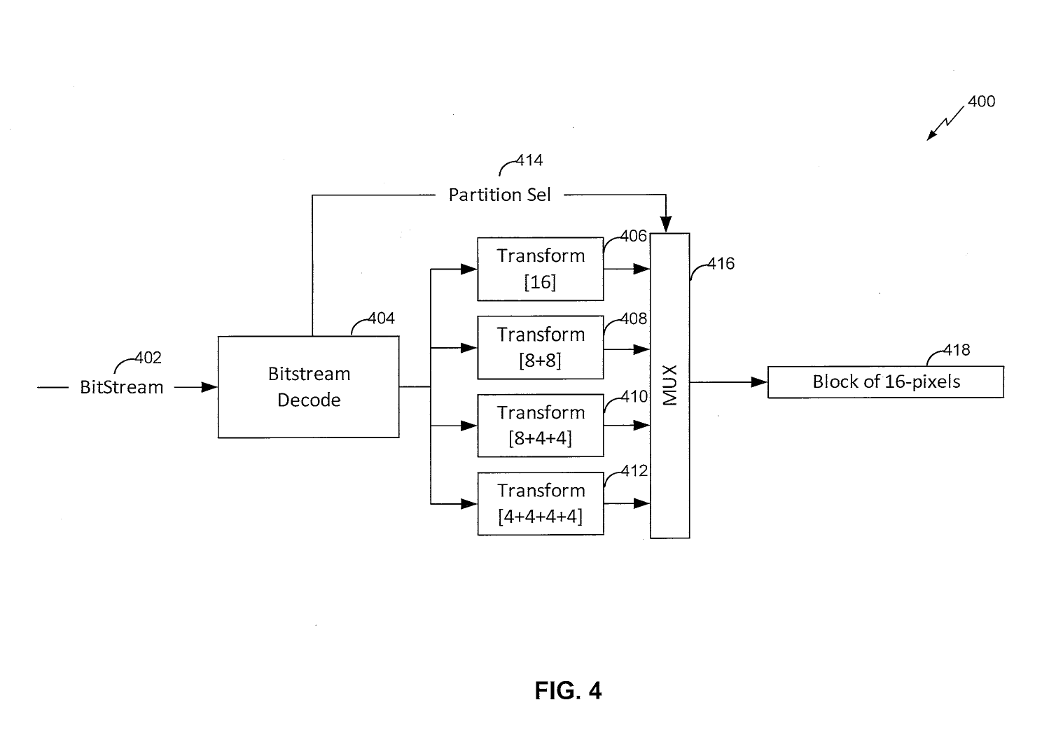

On the decoder side as illustrated in FIG. 4, a decoder (e.g., the video decoder 30) or a component thereof (e.g., bitstream decode 404) uses the transform partition information (e.g., the transform partition type indicated by the partition select flag or syntax element 320) included in the input bitstream 402 to select one or more inverse transforms (e.g., inverse of the transforms associated with the transform blocks 304, 306, 308, or 310 selected by encoder 20) to be used in decoding the compressed pixel data. For example, the decoder extracts the transform coefficients and partition select signal 414 from the input bitstream 402. The transform coefficients are passed to all four inverse transform blocks 406, 408, 410, and 412 and the partition select signal 414 is used to select the desired inverse transform(s).

In some existing hardware implementations of the decoder, a separate inverse transform block is used for each partition type. For example, if the encoder is configured to select from four different partition types as illustrated in FIG. 3, a corresponding decoder that is configured to decode bitstreams (e.g., input bitstream 402) generated by the encoder also includes four sets of hardware (e.g., registers, adders, subtractors, etc. that are not shared among each other) each corresponding to transforms 406, 408, 410, and 412 as illustrated in FIG. 4, Each inverse transform produces a set of output values that are fed to the MUX 416, and the decoder selects one of them based on the partition select signal 414 (or another flag or syntax element that indicates the partition type used for encoding the given block) and obtains the pixel values of the 16-pixel block 418.

Hardware implementation shown in FIG. 4 would require seven independent inverse transform blocks to decode the four partition structures (e.g., one 16-pixel block, two 8-pixel blocks, and four 4-pixel blocks). In order to reduce the implementation cost (e.g., the chip area used to implement the decoder) on the decoder side, the inverse transform functions may be implemented by reorganizing and reusing certain arithmetic operations among the four inverse transform types (e.g., 16, 8+8, 8+4+4, and 4+4+4+4).

### Hardware Implementation

As discussed above, existing approaches utilize independent transform functions (e.g., seven independent transform functions in the example of FIG. 4) to decode transform-coded bitstreams that include multiple partition sizes. However, using multiple inverse transform blocks to decode the incoming partitioned bitstream detrimentally affects the cost-effectiveness of the decoder, since hardware implementation is especially sensitive to chip area and/or implementation cost on the decoder side. Thus, an improved method for decoding transform-coded bitstreams that involve multiple transform partition sizing in a manner that is more cost-effective is desired.

For example, an example implementation of a 16-point transform may include adders and subtractors. These adders and subtractors may all be needed to perform the 16-point transform (or inverse transform), but the same adders and subtractors (or other hardware of the 16-point transform) may also be utilized to perform other transforms such as 8-point and 4-point transforms without having to add the full transform structure necessary to implement such 8-point and 4-point transforms that are separate and independent from the hardware used for implementing the 16-point transform. In other words, by reusing certain portions of the hardware used to implement the various transforms that the encoder and/or decoder may need to perform, the hardware requirements for implementing such transforms can be reduced.

### Selective Bypassing, Rerouting, or Reordering

In some embodiments of the present disclosure, the 16-point transform can be used to implement other types of transforms by selectively shutting down or bypassing certain portions of the 16-point transform and/or re-routing or re-ordering inputs, outputs, or other intermediate nodes in the 16-point transform. For example, one or more MUXs may be added to the 16-point transform so that one part of the hardware is bypassed for 4-point transforms and another part of the hardware is bypassed for 8-point transforms. Although adding such MUXs would add to the cost/chip area, the cost and/or the chip area added by such MUXs would still be far less than having fully implemented hardware transforms for each transform partition type.

### Reusing Hardware Structure

Because the partition type used for encoding is explicitly signaled (e.g., partition select signal 414 of FIG. 4), and on the decoder side, the inverse transform of only a single partition type needs to be performed for each transform block of 16 input coefficients, the decoder implementation cost for partitioned transform can be reduced by reusing and sharing certain portions of the hardware of the largest transform type. For example, in some implementations, one 16-point inverse Hadamard transform is used to produce the four transform partition types (e.g., 16, 8+8, 8+4+4, and 4+4+4+4). In some embodiments, no additional adders or subtractors are used to implement inverse transforms other than the 16-point transform. Thus, implementation cost and/or chip area association with the decoder can be reduced.

In some embodiments of the present disclosure, for each transform partition type, arithmetic terms in the largest transform type are reused to implement the transform partition type. This allows the implementation of all required transform types while maintaining a low implementation area/cost, especially on the decoder side, where area/cost is more critical. Although certain aspects of the present disclosure are described with respect to the decoder side, the techniques described in the present disclosure may be applicable to the encoder side as well (e.g., by reusing and sharing arithmetic functions of the largest transform type to implement other transform types).

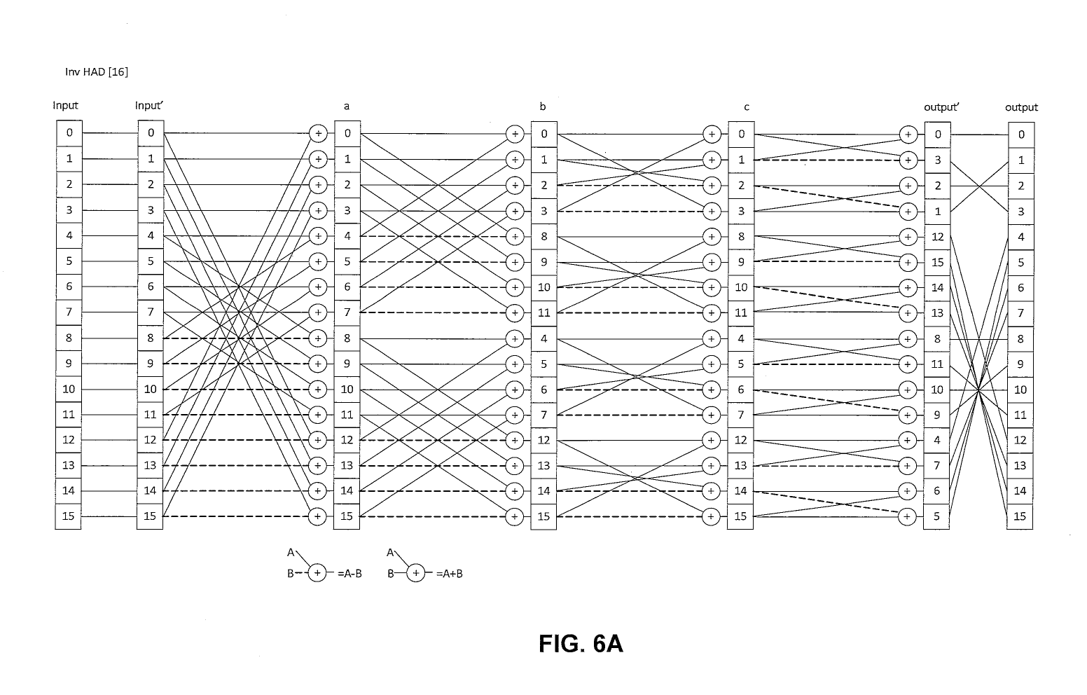

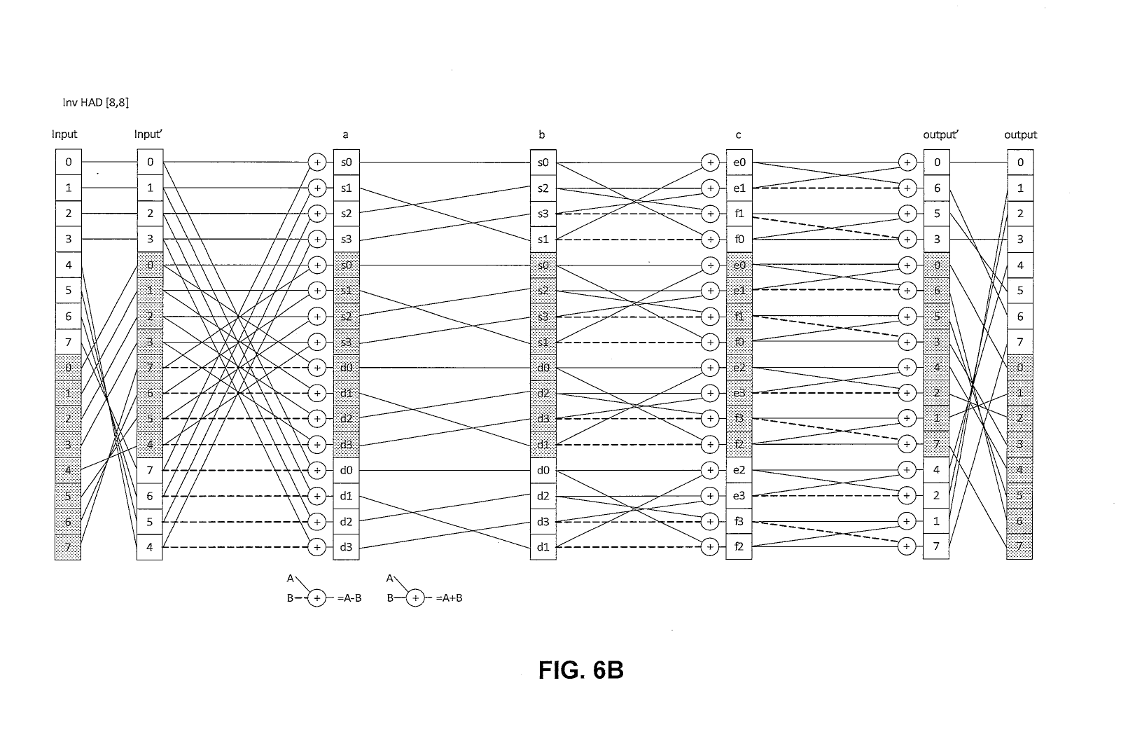

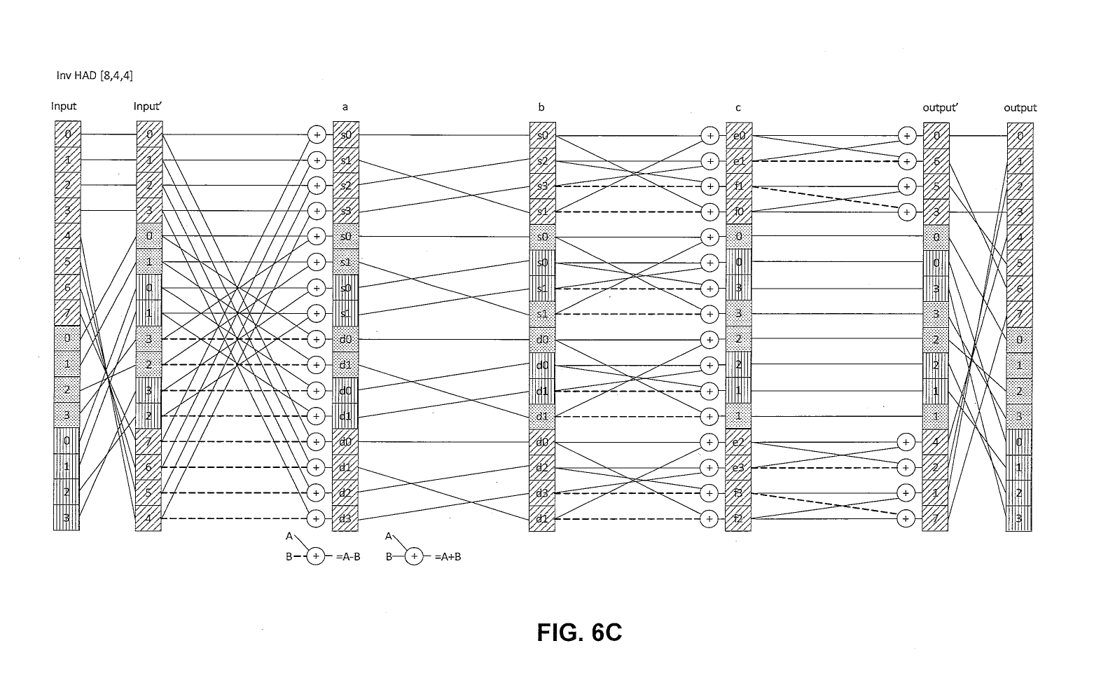

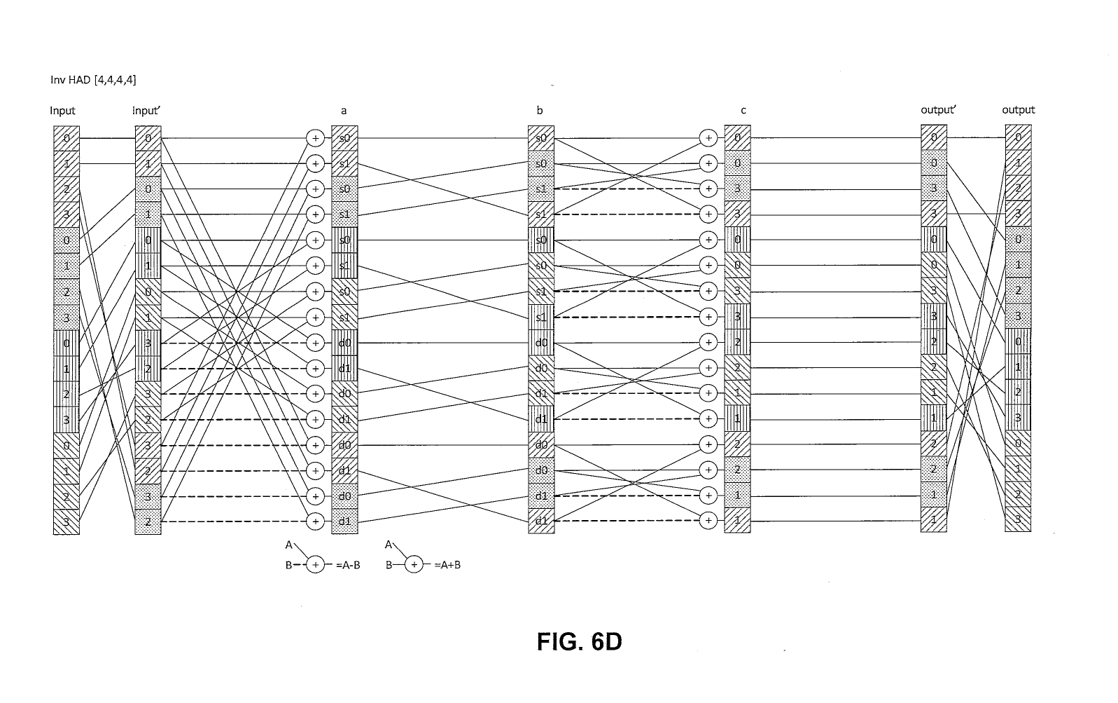

For each transform partition type, the full 16-point inverse Hadamard transform is reconfigured to utilize make use of common math operations to perform the following inverse transforms: (i) one 16-point inverse transform, (ii) two 8-point inverse transform, (iii) one 8-point inverse transform and two 4-point inverse transforms, and (iv) four 4-point inverse transform. Example implementations of such transforms are illustrated in FIGS. 6A-6D, respectively.

For each partition type, the input-to-input′ and output-to-output′ stages are used to reorder the input and output data for the respective transform modes. Further, by bypassing some internal hardware stages of the full 16-point inverse transform function, the inverse transform block is reconfigured to provide the four partition types as described above.

### Example Implementation: 8+8

For transform partition type [8,8], as illustrated in FIG. 6B, the input data is place in the 16-point input holding buffer as two concatenated 8-point samples. The input data is reordered and placed in the intermediate input′ stage (e.g., which may be registers or buffers holding the transform coefficient values). Math operations between stage a-to-b are bypasses (with some reordering), and the final output-to-output′ stage is configured to reorder the final output back to two 8-point concatenated data structure.

### Example Implementation: 8+4+4

For the mixed transform partition type [8,4,4], as illustrated in FIG. 6C, the input data is placed in the input buffer with data of the 8-point samples in the first eight locations followed by the two 4-point data. As stated in the other partition types, the input to input′ stage is used for reordering the data, stage a-to-b includes bypasses and reordering, and only eight bits are bypassed for the 4-point inverse transform in stage c-to-output′. The final output′ data is reordered to produce the data structure of [8,4,4].

### Example Implementation: 4+4+4+4

For partition type [4,4,4,4], as illustrated in FIG. 6D, the four input data is placed in the input holding buffer as four concatenated 4-point samples. The input data is reordered and placed in the intermediate input′ stage. The math operation between a-to-b and c-to-output′ stage are bypassed, with the output ‘-to-output stage configured to reconstruct the output’ data back to a four 4-point data structure.

### Example Flowchart for Reusing Transform Hardware Structure

With reference to FIG. 7, an example procedure for reusing transform structure for multi-partition transforms will be described. The steps illustrated in FIG. 7 may be performed by a video decoder (e.g., the video decoder 30 in FIG. 2B) or component(s) thereof. For convenience, method 700 is described as performed by a decoder (also simply referred to as coder), which may be the video decoder 30 or another component. Although the method 700 is described in the context of a video decoder, the techniques described herein (e.g., reusing transform structure for multi-partition transforms) may be extended to video encoders.

The method 700 begins at block 701. At block 705, the decoder determines a transform partition type associated with a block of video data in a coded bitstream. The block is associated with a plurality of transform coefficients determined at least in part via applying one or more transform functions on a plurality of pixel values associated with the block. In some embodiments, the transform partition type associated with the block of video data indicates the transform (e.g., the one or more functions) performed for obtaining the plurality of transform coefficients. For example, the transform partition type may indicate that a single 16-point transform is performed on a block of video data containing 16 pixels. In another example, the transform partition type may indicate that two 8-point transforms are performed on the first and second sets of 8 pixels in the block. In yet another example, the transform partition type may indicate that a single 8-point transform is performed on 8 of the 16 pixels in the block and two 4-point transforms are performed on the respective 4 pixels of the remaining 8 pixels in the block. In yet another example, the transform partition type may indicate that four 4-point transforms are performed on the first, second, third, and fourth sets of 4 pixels in the block. In some embodiments, the transform partition type may be signaled as a flag or syntax element in the bitstream. For example, values “00”, “01”, “10”, and “11 may indicate that the transform used for a block of video data containing 16 values is (i) a single 16-point transform, (ii) two 8-point transforms, (iii) one 8-point transform and two 4-point transforms, and (iv) four 4-point transforms, respectively.

At block 710, the decoder determines, based on the transform partition type, an order in which the plurality of transform coefficients are to be inputted to one or more inverse transform functions corresponding to the one or more transform functions. The one or more inverse transform functions may each include one or more hardware stages including adders, subtractors, and/or multiplexers. In some embodiments, determining the order may comprise rearranging the transform coefficients based on the transform partition type (e.g., from the order in which the transform coefficients appear in the bitstream to a different order). In some embodiments, only a subset, and not all, of the transform coefficients are rearranged based on the transform partition type.

In one embodiment, the order in which the transform coefficients are to be inputted to the one or more inverse transform functions is the same as the order in which the transform coefficients are signaled or received in the bitstream. For example, as shown in FIG. 6A, based on a determination that the transform partition type corresponds to a single 16-point transform, the decoder may determine the order in which the transform coefficients are to be inputted to the one or more inverse transform functions (e.g., “Input′”) to be the same as the order in which the transform coefficients are signaled or received in the bitstream (e.g., “Input”). In another example, as shown in FIG. 6B, based on a determination that the transform partition type corresponds to two 8-point transforms, the decoder may determine the order in which the transform coefficients are to be inputted to the one or more inverse transform functions (e.g., “Input′”) by rearranging the transform coefficients are signaled or received in the bitstream (e.g., “Input”) as shown in FIG. 6B. In this example, the first 4 coefficients remain unchanged, but the following 4 coefficients are reversed and placed at the end of the 16-coefficient block, and the last 8 coefficients are each moved up 4 spots in the 16-coefficient block.

In yet another example, as shown in FIG. 6C, based on a determination that the transform partition type corresponds to one 8-point transform and two 4-point transforms, the decoder may determine the order in which the transform coefficients are to be inputted to the one or more inverse transform functions (e.g., “Input′”) by rearranging the transform coefficients are signaled or received in the bitstream (e.g., “Input”) as shown in FIG. 6C. In this example, coefficients 0, 1, 2, 3, 4, 5, 6, 7, 8, 9, 10, 11, 12, 13, 14, and 15 of the 16-coefficient block (“Input”) are rearranged to result in coefficients 0, 1, 2, 3, 8, 9, 12, 13, 11, 10, 15, 14, 7, 6, 5, and 4 (“Input”). In yet another example, as shown in FIG. 6D, based on a determination that the transform partition type corresponds to four 4-point transforms, the decoder may determine the order in which the transform coefficients are to be inputted to the one or more inverse transform functions (e.g., “Input′”) by rearranging the transform coefficients are signaled or received in the bitstream (e.g., “Input”) as shown in FIG. 6D. In this example, coefficients 0, 1, 2, 3, 4, 5, 6, 7, 8, 9, 10, 11, 12, 13, 14, and 15 of the 16-coefficient block (“Input”) are rearranged to result in coefficients 0, 1, 4, 5, 8, 9, 12, 13, 10, 112, 3, 8, 9, 12, 13, 11, 10, 15, 14, 7, 6, 5, and 4 (“Input′”).

At block 715, the decoder obtains a plurality of output values at least in part via inputting the plurality of transform coefficients to the one or more inverse transform functions in the determined order. In some embodiments, the one or more inverse transform functions include one or more stages of arithmetic operations and/or rearrangement operations. For example, as shown in FIG. 6A, the stage between “Input′” and “a” includes, for each transform coefficient in the 16-coefficient block “Input′”, either an addition (indicated by two solid lines) or a subtraction (indicated by one solid line and one dashed line). As shown in FIG. 6A, additional stages between “a” and “b”, between “b” and “c”, and between “c” and “output′” each include a plurality of arithmetic operations (e.g., 16 separate operations each). Based on the transform partition type, some of the stages may be bypassed, as shown in FIG. 6B. For example, while the stages between “Input′” and “a”, between “b” and “c”, and “c” and “output′” reuse some or all of the arithmetic operations of the 16-point inverse transform (e.g., shown in FIG. 6A), the stage between “a” and “b” bypasses the arithmetic operations and rearranges the variables in a given order (e.g., based on the transform partition type). In some embodiments, one or more stages may bypass a portion of the 16 coefficients/variables used in the inverse transform, but not all of the 16 coefficients/variables. For example, as shown in FIG. 6C, the stage from “c” to “output′” reuses the arithmetic operations of the 16-point inverse transform (e.g., shown in FIG. 6A) for the first 4 variables (e0, e1, f1, and f0) and the last 4 variables (e2, e3, f3, and f2), but bypasses the arithmetic operations for the middle 8 variables (0, 0, 3, 3, 2, 2, 1, and 1).

The output values resulting from inputting the transform coefficients to the one or more inverse transform functions in the determined order may further be rearranged based on the transform partition type. As illustrated in FIGS. 6A-6D, the output values (e.g., going from “output′” to “output”) may be rearranged in different ways based on the transform partition type.

At block 720, the decoder decodes the block of video data in the coded bitstream based at least in part on the plurality of output values. For example, the output values may be raw pixel values. In another example, the output values may be residual values and further motion compensation may need to be performed to obtain the corresponding pixel values. The method 700 ends at block 725.

In the method 700, one or more of the blocks shown in FIG. 7 may be removed (e.g., not performed) and/or the order in which the method is performed may be switched. In some embodiments, additional blocks may be added to the method 700. For example, the decoder may further selectively bypass one, some, or all of the stages in the inverse transform. In some embodiments, a single stage of a transform function includes a mathematical operation for each transform coefficient inputted to the transform function. In another example, the output values may be rearranged before being used to decode the block of video data. The embodiments of the present disclosure are not limited to or by the example shown in FIG. 7, and other variations may be implemented without departing from the spirit of this disclosure.

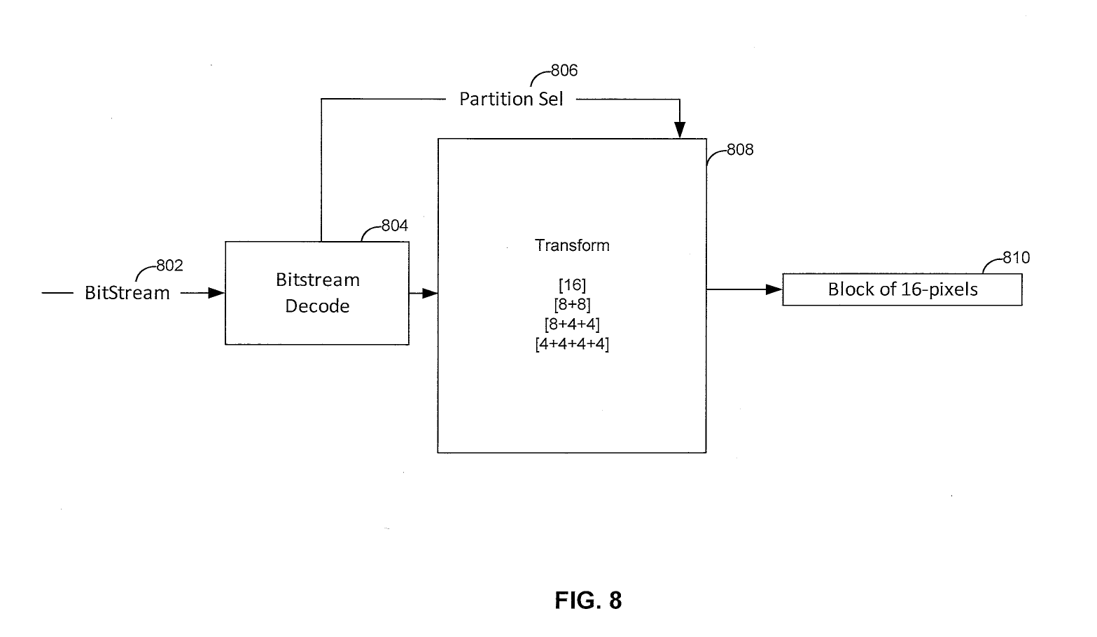

FIG. 8 illustrates an example of transform partitioning on the decoder side in accordance with aspects described in this disclosure. Upon receiving the bitstream 802, at block 804, the decoder decodes the transform coefficients and the partition select signal 806. The transform coefficients are inputted to the transform 808 configured to perform various inverse transforms. The transform 808 performs the appropriate inverse transform based on the received partition select signal 806 and outputs a 16-pixel block 810.

### Other Considerations

Information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, and algorithm steps described in connection with the embodiments disclosed herein may be implemented as electronic hardware, computer software, or combinations of both. To clearly illustrate this interchangeability of hardware and software, various illustrative components, blocks, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as devices or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software or hardware configured for encoding and decoding, or incorporated in a combined video encoder-decoder (CODEC). Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, or units are described in this disclosure to emphasize functional aspects of devices configured to perform the disclosed techniques, but do not necessarily require realization by different hardware units. Rather, as described above, various units may be combined in a codec hardware unit or provided by a collection of inter-operative hardware units, including one or more processors as described above, in conjunction with suitable software and/or firmware.

Although the foregoing has been described in connection with various different embodiments, features or elements from one embodiment may be combined with other embodiments without departing from the teachings of this disclosure. However, the combinations of features between the respective embodiments are not necessarily limited thereto. Various embodiments of the disclosure have been described. These and other embodiments are within the scope of the following claims.

What is claimed is:

1. A method for decoding a block of video data in a coded bitstream, comprising:
determining a transform partition type associated with the block, the block associated with a plurality of transform coefficients determined at least in part via applying one or more transform functions on a plurality of pixel values associated with the block;
determining, based on the transform partition type, an order in which the plurality of transform coefficients are to be inputted to one or more inverse transform functions corresponding to the one or more transform functions;
obtaining a plurality of output values at least in part via inputting the plurality of transform coefficients to the one or more inverse transform functions in the determined order; and
decoding the block of video data in the coded bitstream based at least in part on the plurality of output values.

2. The method of claim 1, wherein determining the order in which the plurality of transform coefficients are to be inputted to the one or more inverse transform functions comprises rearranging the plurality of transform coefficients based at least in part on the transform partition type.

3. The method of claim 1, wherein determining the order in which the plurality of transform coefficients are to be inputted to the one or more inverse transform functions comprises rearranging a portion, but not all, of the plurality of transform coefficients based at least in part on the transform partition type.

4. The method of claim 1, further comprising selectively bypassing one or more arithmetic operation stages of the one or more inverse transform functions based at least in part on the transform partition type associated with the block of video data.

5. The method of claim 1, further comprising selectively bypassing a portion, but not all, of arithmetic operations of a single stage of the one or more inverse transform functions based at least in part on the transform partition type associated with the block of video data, the single stage including one arithmetic operation for each transform coefficient inputted to the one or more inverse transform functions.

6. The method of claim 1, wherein the one or more inverse transform functions comprise one or more of a 16-point Hadamard inverse transform function, an 8-point Hadamard inverse transform function, or a 4-point Hadamard inverse transform function.

7. The method of claim 1, further comprising rearranging the plurality of output values of the one or more inverse transform functions based at least in part on the transform partition type.

8. The method of claim 1, wherein the block of video data corresponds to one of (i) a row of 16 pixels in a picture coded in the bitstream, (ii) two rows of 8 pixels in the picture coded in the bitstream, or (iii) four rows of 4 pixels in a picture coded in the bitstream.

9. The method of claim 1, wherein the one or more inverse transform functions include one or more arithmetic operation stages, each arithmetic operation stage comprising one or more of addition operations or subtraction operations.

10. The method of claim 1, wherein the transform partition type is one other than a 16-point transform, and the one or more inverse transform functions comprise a 16-point inverse transform function.

11. The method of claim 1, wherein the transform partition type comprises one of (i) two 8-point transforms, (ii) one 8-point transform and two 4-point transforms, or (iii) four 4-point transforms, and the one or more inverse transform functions comprise one 16-point inverse transform function.

12. An apparatus for decoding a block of video data in a coded bitstream, comprising:
a memory configured to store data associated with the block of video data in the coded bitstream; and
a processor in communication with the memory and configured to:
determine a transform partition type associated with the block, the block associated with a plurality of transform coefficients determined at least in part via applying one or more transform functions on a plurality of pixel values associated with the block;
determine, based on the transform partition type, an order in which the plurality of transform coefficients are to be inputted to one or more inverse transform functions corresponding to the one or more transform functions;
obtain a plurality of output values at least in part via inputting the plurality of transform coefficients to the one or more inverse transform functions in the determined order; and
decode the block of video data in the coded bitstream based at least in part on the plurality of output values.

13. The apparatus of claim 12, wherein the processor is further configured to determine the order in which the plurality of transform coefficients are to be inputted to the one or more inverse transform functions at least in part via rearranging the plurality of transform coefficients based at least in part on the transform partition type.

14. The apparatus of claim 12, wherein the processor is further configured to determine the order in which the plurality of transform coefficients are to be inputted to the one or more inverse transform functions at least in part via rearranging a portion, but not all, of the plurality of transform coefficients based at least in part on the transform partition type.

15. The apparatus of claim 12, wherein the processor is further configured to selectively bypass one or more arithmetic operation stages of the one or more inverse transform functions based at least in part on the transform partition type associated with the block of video data.

16. The apparatus of claim 12, wherein the processor is further configured to selectively bypass a portion, but not all, of arithmetic operations of a single stage of the one or more inverse transform functions based at least in part on the transform partition type associated with the block of video data, the single stage including one arithmetic operation for each transform coefficient inputted to the one or more inverse transform functions.

17. The apparatus of claim 12, wherein the one or more inverse transform functions comprise one or more of a 16-point Hadamard inverse transform function, an 8-point Hadamard inverse transform function, or a 4-point Hadamard inverse transform function.

18. The apparatus of claim 12, wherein the processor is further configured to reaarange the plurality of output values of the one or more inverse transform functions based at least in part on the transform partition type.

19. The apparatus of claim 12, wherein the block of video data corresponds to one of (i) a row of 16 pixels in a picture coded in the bitstream, (ii) two rows of 8 pixels in the picture coded in the bitstream, or (iii) four rows of 4 pixels in a picture coded in the bitstream.

20. The apparatus of claim 12, wherein the one or more inverse transform functions include one or more arithmetic operation stages, each arithmetic operation stage comprising one or more of addition operations or subtraction operations.

21. The apparatus of claim 12, wherein the transform partition type is one other than a 16-point transform, and the one or more inverse transform functions comprise a 16-point inverse transform function.

22. The apparatus of claim 12, wherein the transform partition type comprises one of (i) two 8-point transforms, (ii) one 8-point transform and two 4-point transforms, or (iii) four 4-point transforms, and the one or more inverse transform functions comprise one 16-point inverse transform function.

23. A non-transitory computer readable medium comprising code that, when executed, causes an apparatus to:
store data associated with a block of video data in a coded bitstream;
determine a transform partition type associated with the block, the block associated with a plurality of transform coefficients determined at least in part via applying one or more transform functions on a plurality of pixel values associated with the block;
determine, based on the transform partition type, an order in which the plurality of transform coefficients are to be inputted to one or more inverse transform functions corresponding to the one or more transform functions;
obtain a plurality of output values at least in part via inputting the plurality of transform coefficients to the one or more inverse transform functions in the determined order; and
decode the block of video data in the coded bitstream based at least in part on the plurality of output values.

24. The computer readable medium of claim 23, wherein the code causes the apparatus to determine the order in which the plurality of transform coefficients are to be inputted to the one or more inverse transform functions at least in part via rearranging the plurality of transform coefficients based at least in part on the transform partition type.

25. The computer readable medium of claim 23, wherein the code further causes the apparatus to selectively bypass one or more arithmetic operation stages of the one or more inverse transform functions based at least in part on the transform partition type associated with the block of video data.

26. The computer readable medium of claim 23, wherein the transform partition type comprises one of (i) two 8-point transforms, (ii) one 8-point transform and two 4-point transforms, or (iii) four 4-point transforms, and the one or more inverse transform functions comprise one 16-point inverse transform function.

27. A video coding device configured to decode a block of video data in a coded bitstream, the video coding device comprising:
means for storing data associated with a block of video data in a coded bitstream;
means for determining a transform partition type associated with the block, the block associated with a plurality of transform coefficients determined at least in part via applying one or more transform functions on a plurality of pixel values associated with the block;
means for determining, based on the transform partition type, an order in which the plurality of transform coefficients are to be inputted to one or more inverse transform functions corresponding to the one or more transform functions;
means for obtaining a plurality of output values at least in part via inputting the plurality of transform coefficients to the one or more inverse transform functions in the determined order; and
means for decoding the block of video data in the coded bitstream based at least in part on the plurality of output values.

28. The video coding device of claim 27, wherein determining the order in which the plurality of transform coefficients are to be inputted to the one or more inverse transform functions comprises rearranging the plurality of transform coefficients based at least in part on the transform partition type.

29. The video coding device of claim 27, further comprising means for selectively bypassing one or more arithmetic operation stages of the one or more inverse transform functions based at least in part on the transform partition type associated with the block of video data.

30. The video coding device of claim 27, wherein the transform partition type comprises one of (i) two 8-point transforms, (ii) one 8-point transform and two 4-point transforms, or (iii) four 4-point transforms, and the one or more inverse transform functions comprise one 16-point inverse transform function.
